(19) United States
(12) Patent Application Publication
(10) Pub. No.: US 2003/0198912 A1
(43) Pub. Date: Oct. 23, 2003

(54) Thin, polymeric orthodontic appliance with headgear channels

(76) Inventor: James Mah, Hermosa Beach, CA (US)

Correspondence Address: JAMES K. MAH, 62 THE STRAND, HERMOSA BEACH, CA, 90254, US

(21) Appl. No.: 10/131,710

(22) Filed: Apr. 23, 2002

(51) Int. Cl. A61C 3/00

(52) U.S. Cl. 433/6; 433/5

(57) ABSTRACT

This invention preferably describes a thin, removable polymeric appliance with tooth receiving cavities and two headgear receiving protrusions, each located on opposite sides of the appliance, intended to receive the ends of an inner bow of a headgear assembly in order to correct a patient's Class II or Class III mal-occlusion. Each headgear receiving protrusion has a channel to receive the headgear assembly. The protrusions are generally filled with a material intended to provide additional rigidity to the protrusions and withstand the forces generated by the headgear assembly. The appliance is removable and clear, and therefore offers aesthetic benefits in comparison to conventional orthodontic treatment.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### FIELD OF THE INVENTION

The present invention relates to the field of orthodontics and dentistry. More specifically, this invention relates to the design, manufacture and use of a thin, aesthetic orthodontic polymeric appliance that fits over a patient's dental set and contains protrusions for receiving the components of orthodontic headgear.

### BACKGROUND OF THE INVENTION

In some patients with malocclusion, the upper jaw is ahead, or protrudes anteriorly, of the lower jaw resulting in a bite discrepancy known as a Class II malocclusion. In growing patients, this type of problem can be corrected by use of an orthodontic headgear. Orthodontic headgear consists of a facebow with inner and outer bows, and a neckstrap or headstrap. The inner bow extends into the patient's mouth and is inserted into receiving tubes on metal barrels welded to bands adhered to the teeth. These metal bands are not intended for removal by the patient and remain in the patient's mouth when the headgear is removed. The outer bow extends around the patient's head and has attachments for connection to the neckstrap. The neckstrap is worn behind the patient's head. In some instances, the orthodontic headgear is supplemented with an additional removable appliance that has wires for attachment to the anterior and/or posterior teeth and acrylic portions that extend around the teeth and cover the palate.

In some patients with malocclusion, the upper jaw is behind, or posterior, of the lower jaw resulting in a bite discrepancy known as Class III malocclusion. In growing patients, this type of problem can be corrected by using an orthodontic headgear design to pull the upper jaw anteriorly, otherwise known as reverse-pull headgear. The headgears designed to correct this type of problem are generally of the facemask design that rests on the patients face. Typically, elastics are worn from hooks on the facemask to hooks on the braces. Other variations such as attachment of the elastics to palatal expander appliances are common.

The patient is instructed to wear the headgear at least 14 hours per day and if growth and patient cooperation are sufficient, the malocclusion is typically corrected in 9-12 months. In Class II malocclusions, the headgear is designed to impede or arrest anterior growth of the upper jaw, allowing the lower jaw to continue to grow resulting in correction of the malocclusion. In Class III malocclusions, the headgear is designed to pull the upper jaw anteriorly, allowing it to correctly occlude with the lower jaw.

Common to the orthodontic headgear designs for correction of Class II or Class III malocclusions are the use of metal barrels welded to bands that are adhered to the patient's teeth and the use of adjunctive appliances such as biteplates or retainers that consist of wires for tooth attachment and an acrylic body for bulk, relating to the teeth, and covering the palate. Unfortunately, all these wire and acrylic components, in addition to the facebow and neckstrap/facemask, add to the social stigma of wearing these appliances, a leading cause of non-cooperation. Very commonly, headgear treatment begins before the braces. In severe malocclusions and instances where growth and or cooperation are lacking, the period of headgear wear is extended by many more months. Since the metal barrel bands are in the patient's mouth for the period of headgear wear and the period of braces, they can be in the mouth for several years. During this period, problems arise from difficulties maintaining oral hygiene around the banded teeth. Occasionally, decalcification or caries develop under the metal barrel bands. Additionally, bands occasionally loosen and can potentially fall off the teeth.

From the orthodontist's perspective, placement of the metal barrel bands, headgear, and adjunctive appliances, takes several visits to perform all the necessary clinical and laboratory procedures. Additionally, inspection, adjustment and maintenance of all the components requires many follow-up visits. Together, these add to overall costs and clinical inefficiency. The above prior art describes orthodontic headgear appliances that are in clinical use but have the disadvantages of appearance, cleanliness, and clinical inefficiency.

U.S. Pat. No. 4,330,272, issued May 18, 1982 and invented by Bergerson, describes a means for attaching headgear to a dental positioner. The dental positioner described in the patent is a single unit with tooth-receiving cavities for both the maxillary and mandibular dentition. The patient generates tooth repositioning forces by closing his mouth and forcing his teeth into the tooth receiving cavities. The masticulatory, lingual, labial, and buccal muscles therefore generate the tooth repositioning forces. The positioner has either metal headgear receiving tubes attached to a plate that is inserted into receiving holes molded into the positioner, or the headgear is inserted directly into the positioner through existing breathing holes. However, this appliance is very noticeable, and does not provide a solution for aesthetic treatment by providing a thin, substantially clear appliance.

Dr. Henry Nahoum describes a thin, clear polymeric tray with the ability to receive headgear in his insightfully written article, “The vacuum formed dental contour appliance,” Vol. 30, No. 9, pages 385-390 of The New York State Dental Journal, Nov. 1964. However the polymeric tray is intended to be mounted over a molar band that has a welded headgear tube in order to receive the headgear assembly. A hole is created in the polymeric tray to allow the headgear tube welded to the molar band to receive the end of a headgear assembly.

Align Technology, Inc. introduced a polymeric teeth-repositioning system as an option to traditional orthodontic treatment techniques. The system is described in U.S. Pat. No. 5,975,893, issued Nov. 2, 1999. The system involves incrementally moving teeth using a plurality of polymeric repositioners, where each repositioner incrementally moves one or more of the patient's teeth by relatively small amounts to a successive tooth arrangement. The tooth movement is accomplished by providing a series of polymeric repositioners with differing geometries for the teeth that are to be moved. These polymeric repositioners replace the brackets and archwires. The polymeric repositioners are thin and clear, which makes them more difficult to detect than conventional brackets. Additionally, they are removable, which allows the patient to effectively maintain oral hygiene. However, the described system does not allow for attachment of headgear appliances and is therefore limited in its ability to treat Class II or Class III orthodontic cases.

Therefore, the improvement upon prior art is an appliance that is aesthetic, allows for cleansing, is easily removed, is clinically efficient, and allows for attachment of a headgear assembly.

### BRIEF SUMMARY OF THE INVENTION

In contrast to prior apparatus and systems, this invention preferably describes a thin, substantially clear removable polymeric appliance designed to fit the patient's maxillary dental set with tooth receiving cavities and two headgear receiving protrusions, each located on opposite sides of the appliance, intended to receive the ends of an inner bow of a headgear assembly in order to correct a patient's Class II or Class III mal-occlusion without the necessity of orthodontic bands or brackets adhered to the surfaces of the patient's dentition. Each headgear receiving protrusion has a channel to receive the headgear assembly. The protrusions extend from the patient's dental surface towards the cheek tissue and are generally positioned near the patient's first molar. The remainder of the appliance closely follows the contour of the patient's dental set and is substantially clear, so as to provide an aesthetic assembly. Preferably, the tooth receiving cavities match the actual positions of the teeth of the patient's dental set, and the appliance is removed when the headgear is not worn. The headgear and the appliance are generally worn at night, or when the patient is sleeping. Since the appliance is removable, there are no unaesthetic signs of orthodontic treatment during the day or when the patient desires to conceal they are undergoing treatment, thereby reducing or eliminating the social stigma associated with orthodontic treatment utilizing headgear.

Alternatively, the tooth receiving cavities are formed to provide tooth-repositioning forces. The tooth-repositioning forces are produced by the difference in the actual positions of the patient's teeth and the geometry of the tooth receiving cavities of the appliance. Therefore, the appliances may aesthetically reposition the teeth during the daytime and the headgear may be worn at night. Since the appliance is thin and clear, it is more difficult to detect than conventional orthodontic treatment and provides the option of utilizing headgear during treatment while maintaining aesthetic benefits over conventional treatment.

The polymeric material used to construct the appliance defines the shape of the protrusions, however the protrusions are preferably filled with a material intended to provide additional rigidity and withstand the forces generated by the headgear assembly. Preferably, the material is relatively clear material such as cured acrylic.

In another alternative embodiment, an inner diameter of a metal tube forms the channel of each of the headgear receiving protrusion. The tube is surrounded with acrylic or other materials bounded by the surface of the patient's dentition and the polymeric material used to form the appliance. In another alternative embodiment, the mesial ends of the headgear receiving protrusions are flared to allow the patient to insert the ends of the headgear assembly more easily.

The appliance is removable and clear, and therefore offers aesthetic benefits in comparison to conventional orthodontic treatment and provides the additional ability to provide headgear treatment to currently offered aesthetic polymeric dental repositioners.

### BRIEF DESCRIPTION OF DRAWINGS

FIG. 1A illustrates a preferred embodiment of the invention with a headgear assembly.

FIG. 1B illustrates a close-up view of a headgear-receiving protrusion positioned on a patient's right-side.

FIG. 1C illustrates a labial-lingual cross-section of the headgear-receiving protrusion positioned on the patient's right side.

FIG. 1D illustrates a mesial-distal cross-section of the headgear-receiving protrusion positioned on the patient's right side.

FIG. 2A shows a flowchart for a manufacturing process.

FIG. 2B shows a flowchart for manipulating the patient's digital dental information.

FIG. 2C illustrates mounting a wedge on a positive tooth mold.

FIGS. 3-5 illustrate cross-sections of alternative embodiments of the headgear receiving protrusion as viewed from the patient's right side.

FIG. 6A illustrates an alternative embodiment of inserting a cylindrical tube into the headgear-receiving protrusion.

FIGS. 6B-6C illustrate cross-sections of the cylindrical tube inserted into the headgear-receiving protrusion.

FIGS. 7-11D illustrate alternative embodiments.

FIG. 12 illustrates an alternative embodiment of the appliance with a palatal section.

FIG. 13 illustrates a mandibular appliance with headgear receiving protrusions.

FIG. 14 illustrates an alternative embodiment of attaching a tube to a thin, polymeric appliance.

FIG. 15 illustrates an alternative embodiment of an appliance with an invagination intended to receive an attachment appliance positioned on a patient's tooth.

FIG. 16 illustrates an alternative embodiment of an appliance with a groove.

FIGS. 17-18 illustrate an alternative embodiment of an appliance with a section removed.

FIG. 19 illustrates an alternative embodiment of a headgear-receiving attachment appliance attached to a thin polymeric appliance with tooth-receiving cavities.

### DETAILED DESCRIPTION

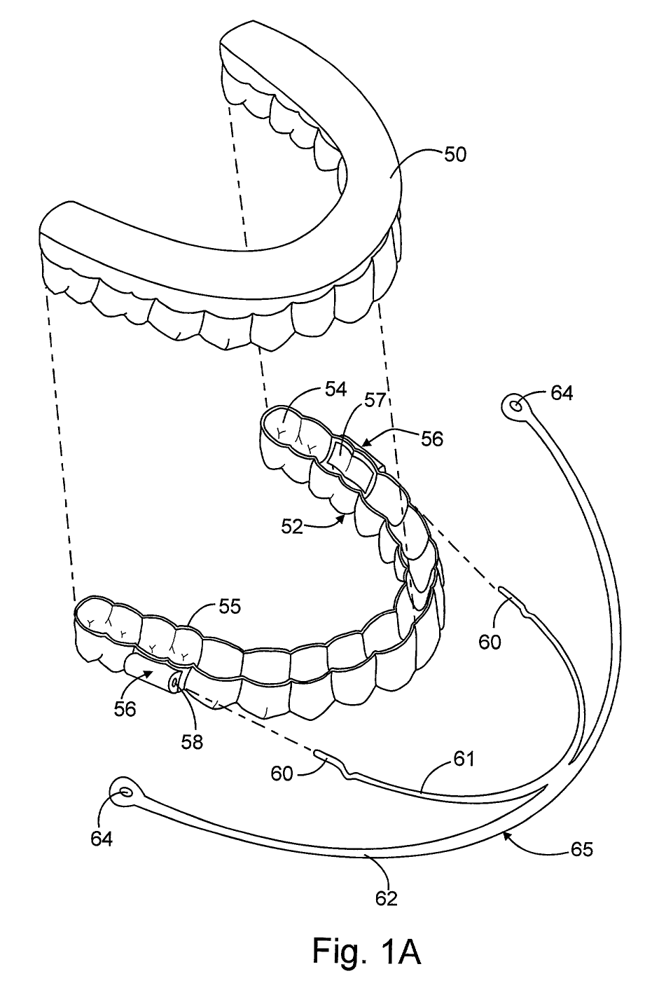

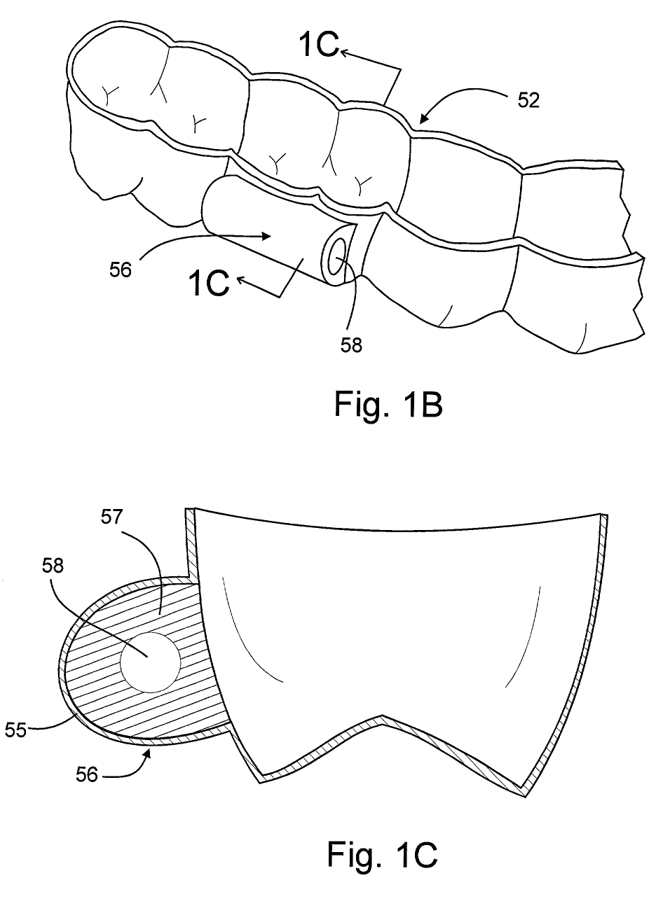

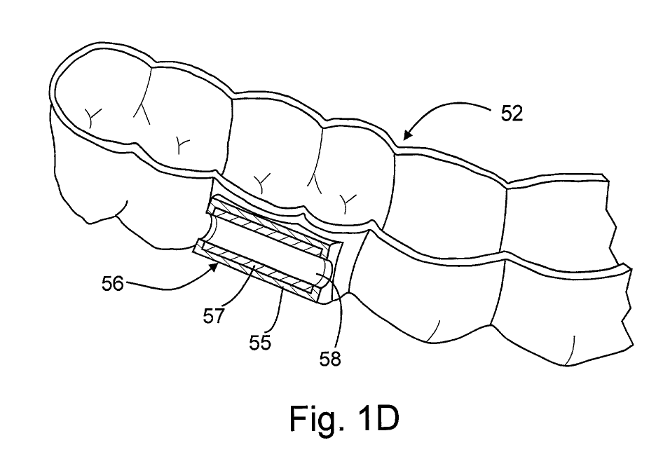

The preferred embodiment of this invention has a general configuration of a thin, substantially clear, polymeric shell appliance 52 with headgear receiving protrusions 56 as illustrated in FIG. 1A. Appliance 52 has a tooth receiving surface 54 comprising a plurality of tooth-receiving cavities meant to receive a patient's upper dental set 50. Preferably, surface 54 matches the actual positions of the teeth of the patient's dental set. Alternatively, surface 54 is designed with differing geometries for one or more of the tooth positions. In these cases, the discrepancy between the tooth receiving surface and the actual positions of the tooth generates tooth movement forces. Appliance 52 is constructed from a thin polymeric material 55 as detailed in the ensuing description. Preferably, material 55 is a polymeric dental thermal forming material commonly used in the field of dentistry and orthodontics. Material 55 can be acetate, butyrate, polyethylene, styrene, co-polyester or vinyl. Appliance 52 has a headgear receiving protrusion 56 on opposing sides. The headgear receiving protrusions are generally located on the patient's left and right hand side. Protrusions 56 have a headgear receiving channel 58 meant to receive headgear prongs 60. Preferably, channels 58 extend completely through protrusions 56. Preferably, protrusions 56 are filled with a material 57. In the preferred embodiment, material 57 is acrylic. Alternatively, material 57 is silicone, a curable dental composite material, metal or plastic.

Referring to FIG. 1A, prongs 60 are located at the end of an inner bow 61. Bow 61 is welded to an outer bow 62. The ends of bow 62 have loops 64 located on opposite sides of bow 62. Loops 64 provide attachment points for a neck or head strap. Prongs 60, bow 61, bow 62 and loops 64 form a metal headgear assembly 65. The neck or head straps are not shown for illustration purposes. Headgear assembly 65 is inserted into channels 58 of protrusions 56 in an anterior to posterior direction. The anterior to posterior direction is hereafter referred to as a mesial-distal direction. Alternatively, a reverse-pull headgear assembly is used to provide mesial forces by insertion through the distal end of protrusions 56.

Fig. 1B illustrates an enlarged view of the preferred embodiment of protrusion 56 as viewed from the patient's right side. The protrusion located on the opposing side of appliance 52 is a mirror image and therefore is not shown for illustration purposes. Preferably, protrusion 56 has a general configuration of half of a cylinder. A rounded surface extends towards the patient's cheek tissue and the flat surfaces are substantially perpendicular to the mesial-distal direction. Preferably, protrusion 56 is formed adjacent to the patient's first molar. Alternatively, protrusion 56 is formed in a different location depending upon the specificities of a patient's particular dental arrangement. FIG. 1C illustrates a cross-section of Fig. 1B. Referring to FIG. 1C, preferably protrusion 56 has a radius of 0.21 inches and therefore extends away from the patient's dentition in the labial direction towards the patient's cheek tissue a distance of 0.21 inches. In the preferred embodiment, protrusion 56 has a length in the mesial-distal direction of 0.16 inches. Alternatively, protrusion 56 extends away from the patient's dentition towards the patient's cheek tissue a distance of at least 0.045 inches and has a length in the mesial-distal direction of at least 0.04 inches. Alternatively, protrusion 56 has a substantially rectangular shape. Alternatively, protrusion 56 has a substantially elliptical shape. Alternatively, protrusion 56 has a polygonal shape determined by the specificities of the patient's dental configuration. Material 55 surrounds material 57 on the surface that extends towards the patient's cheek tissue and is bounded on the opposing side by the patient's dental surface. Material 57 provides structural stability to protrusion 56 and contains channel 58. Channel 58 extends the length of protrusion 56. Channel 58 is designed to receive prong 60. Generally, orthodontic appliance manufacturers construct the prongs of headgear assemblies as either 0.045 inches or 0.051 inches in diameter. Therefore, channel 58 has a diameter of at least 0.045 inches or at least 0.051 inches, depending on the headgear assembly selected for treatment. Preferably, 0.003 inches of clearance is designed between the headgear prong diameter and the diameter of channel 58 in order to allow the patient to insert the headgear prongs without undue difficulty. Alternatively, at least 0.001 inches of clearance between the headgear prongs and channel 58 is utilized. Therefore, channel 58 preferably has a diameter of 0.048 inches for receiving a headgear assembly of 0.045 inches or a diameter of 0.054 inches for receiving a headgear assembly of 0.051 inches. Fig. 1D shows a cross-section of the preferred embodiment of protrusion 56 as viewed from the patient's right side.

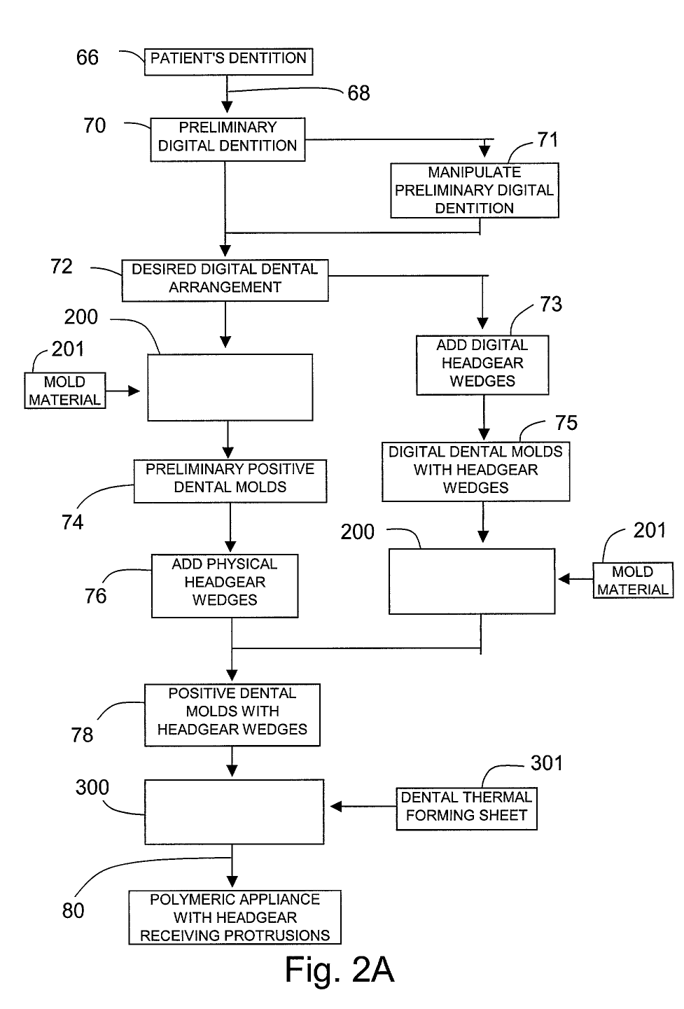

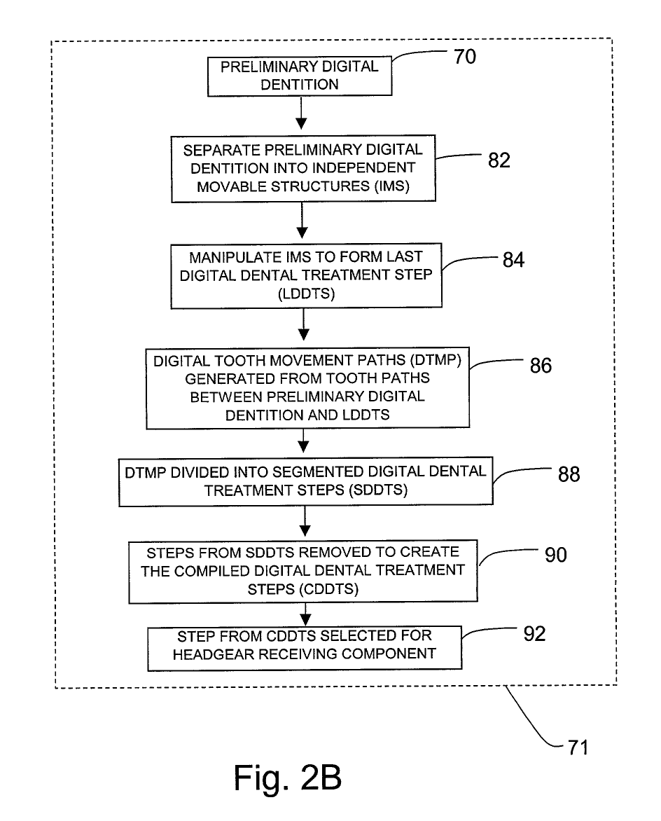

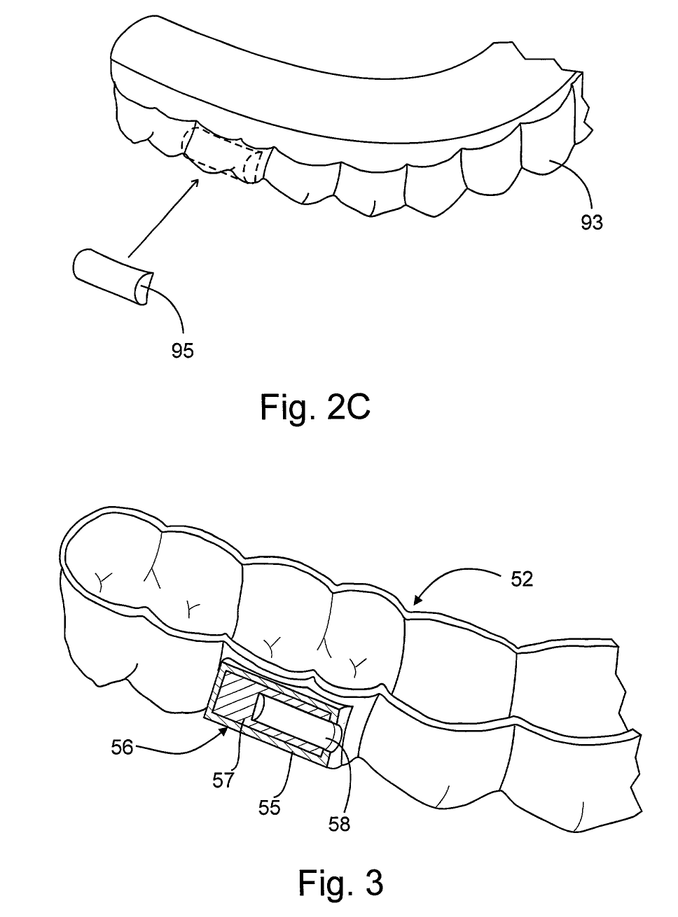

Methods are provided to digitize the patient's dentition in order to create a three dimensional dental mold using a rapid prototyping machine. The three dimensional dental mold is used with a pressure forming machine to construct the appliance with headgear receiving protrusions. Alternatively, conventional stone or plaster dental molds constructed from the patient's alginate impression are utilized for appliance construction. Referring to FIG. 2A, preferably a patient's dentition 66 comprising the maxillary dentition is digitized during step 68. Alternatively, dentition 66 is the patient's mandibular dental set. Occasionally, dentition 66 is both the patient's mandibular and maxillary dentition. Step 68 involves digitizing a physical dental impression or positive mold of the physical impression using a non-contact scanner. Alternatively, a contact digitizer is used to digitize the physical impression or a positive mold of the physical impression. Alternatively, the positive mold of the physical impression is formed using a material such as hydrocolloid, and a contrasting colored material, such as hydrocolloid, is filled in surrounding the positive mold. Successive thin layers of the mold are removed, such as by slicing, milling or sawing. An image-capture device captures the image of the newly exposed surface of the mold after each successive layer is removed. A computer with a microprocessor creates a series of digital model layers by differentiating between the contrasting colors of the successively sliced layers. These images are compiled and a digital skin is placed over the layers and a preliminary digital dentition 70 is produced. Preferably, digital dentition 70 is a three dimensional representation of patient's dentition 66. Alternatively, the practitioner uses a non-contact digitizer that gathers the information directly from the patient in order to produce digital dentition 70. Digital dentition 70 comprises the patient's digital teeth, digital gums, and digital palatte. Alternatively, digital dentition 70 comprises only the patient's teeth. The non-contact digitizer either gathers the information intra-orally using an intra-oral probe, or gathers the information extra-orally, using magnetic resonance imaging, digital X-ray images, or computer-aided tomography.

Referring to FIG. 2A, preferably digital dentition 70 does not require modification to the digital tooth positions and is a desired digital dental arrangement 72. Alternatively, step 71 involves digitally separating the digital teeth from the digital gums and repositioning the digital teeth in order to create desired dental arrangement 72. Creating dental arrangement 72 that is different from dentition 71 is desirable when intra-arch tooth movement is desired while having the capability to utilize headgear during treatment. This method allows for tooth straightening while correcting jaw discrepancies.

Referring to FIG. 2B, the digital teeth are digitally separated from each other and from the digital gums of digital dentition 70 in order to produce digital independent movable structures 82 (IMS). Creating IMS 82 involves digitally cutting digital dentition 70 using a digital cutting tool in a software program for 3D model manipulation. The digital teeth are placed in desired final result positions in order to produce a last digital dental treatment step 84 (LDDTS). The final positions are determined either from a pre-selected orthodontic treatment philosophy, or from the practitioner's specifications for final tooth positions. The tooth movements are those normally associated with orthodontic treatment, including translation in all three orthogonal directions relative to a vertical centerline, rotation of the tooth centerline in the two orthodontic directions (“root angulation” and “torque”), as well as rotation about the tooth centerline. Alternatively, LDDTS 84 is simply a dental configuration different from digital dentition 70. Digital tooth movement paths 86 (DTMP) are created by generating tooth movement paths from the positions of the teeth from digital dentition 70 to their final positions in LDDTS 84. The tooth movement paths of DTMP 86 should incorporate less than 0.20 mm of interference between the digital teeth. This avoids producing DTMP 86 that will produce inefficient or impossible tooth movements due to inter-tooth interference. Once DTMP 86 is produced, it is divided into a progression of 0.1 mm incremental tooth movement iterations in order to create a segmented digital dental treatment steps 88 (SDDTS). SDDTS 88 ideally incorporates a plurality of 0.1 mm tooth movement iterations that follow DTMP 86, however, iteration steps ranging from 0.1 mm to 1.5 mm may be used. Tooth movement iterations are removed from SDDTS 88 in order to create larger tooth movement iterations comprising compiled digital dental treatment steps 90 (CDDTS). Ideally, sufficient steps are removed from SDDTS 88 to create CDDTS 90 with 0.4 mm of tooth movement between treatment steps. If there is less than 0.4 mm of tooth movement for a tooth or teeth required to achieve the final digital tooth position(s) designated by LDDTS 84, then the remaining distance iteration is used for the tooth or teeth. Alternatively, the treatment steps in CDDTS 90 may incorporate less than 0.4 mm of movement between treatment steps, sometimes comprising 0.2 mm of tooth movement. Alternatively, sufficient treatment steps are removed from SDDTS 88 to create CDDTS 90 with more than 0.4 mm of tooth movement between steps. The first treatment step of CDDTS 90 different from digital dentition 70 is a first digital dental treatment step. The last treatment step of CDDTS 90 is LDDTS 84. Intermediate digital dental treatment steps incorporate all digital tooth movement iterations between the first digital dental treatment step and LDDTS 86 of CDDTS 90, if any. The intermediate digital dental treatment steps may incorporate 1 to 40 steps. Generally, the intermediate treatment steps comprise 12 steps. Alternatively, CDDTS 90 comprises only the first treatment step and LDDTS 84 with no intermediate treatment steps. Step 94 involves selecting at least one step from CDDTS 90 for headgear treatment. Referring again to FIG. 2A, the selected step from step 94 is dental arrangement 72. Alternatively, a stone model of the patient's dentition is used for constructing a different dental arrangement. The stone teeth are separated from each other and from the model using a handsaw or a mechanical saw. One or more of the teeth are then re-set on the stone base using wax in order to create a different dental arrangement. Alternatively, a plurality of stone molds with incrementally different tooth positions is created.

Referring to FIG. 2A, preferably dental arrangement 72 is converted to an STL file format and is sent to a rapid prototyping machine 200 to create positive dental mold(s) 74. Preferably, machine 200 is a stereolithography machine, available from 3D Systems, Valencia, Calif. 91355. Mold material 201 is used with machine 200 in order to create mold(s) 74. Preferably, material 201 is a resin commonly used with stereolithography machines. Alternatively, machine 200 is a powder deposition machine available from Z-Corp Burlington, Mass. 01803 and material 201 is a powder that is selectively bound with a binder. Alternatively, conventional stone or plaster dental molds constructed from the patient's alginate impression are utilized for the positive dental mold(s). Step 76 involves physically placing bite-positioning wedges on mold(s) 74 in order to create positive dental molds with headgear wedges 78. Preferably, mold 74 is a three-dimensional solid model of the patient's maxillary dentition. Alternatively, mold 74 is a three-dimensional solid model of the patient's mandibular dentition. Alternatively, several positive molds with the same tooth positions are created.

Referring to FIG. 2C, an illustration of adhering a wedge to an appropriate location on a positive tooth mold from the rapid prototyping machine is shown. Alternatively, a stone model created from an alginate impression is used as the positive tooth mold. A pre-fabricated physical wedge 95 is attached in the appropriate labial position on a positive tooth mold 93. The right side of the mold is a mirror image of the illustration shown in FIG. 2C. Preferably, wedge 95 is half of a cylinder, with radius 0.20 inches. Wedge 95 is 0.14 inches in length in the mesial-distal direction. Alternatively, wedge 95 has dimensions determined according to the specificities of the dental structures of the patient. Alternatively, wedge 95 has a length in the mesial-distal direction of at least 0.038 inches and extends towards the patient's cheek tissue a distance of at least 0.044 inches. The appropriate position is generally determined by the practitioner and given to a technician adhering wedge 95 to mold 93 in the form of a drawing or written instructions. Alternatively, the appropriate position is determined by the technician adhering wedge 95 to mold 93. Preferably, wedge 95 is adhered to mold 90 with an ethyl cyanoacrylate adhesive gel, commonly sold in most hardware stores as instant glue. Alternatively, a light curable adhesive commonly used with bonding orthodontic brackets to teeth is used. Alternatively, a custom impression tray light curable adhesive, such as TRIAD® TruTray™ available from Denstply International Inc., Pa. 17405, is used for adhering wedge 92 to mold 90. Alternatively, any other suitable adhesive is used. Alternatively, the wedges are attached using screws or some other suitable means for physical attaching the wedges to the molds. The wedges can be constructed from a plurality of materials including plastic, metal, wood, cured resin or cured shaping material commonly used in the field of dentistry. Alternatively, a plurality of positive tooth molds with incrementally different tooth positions have wedges placed in similar locations. Alternatively, a plurality of positive tooth molds with incrementally different tooth positions have wedges placed in different locations.

Alternatively, referring to FIG. 2A, digital headgear wedges are added to digital dental arrangement 72 during step 73 in order to create digital dental molds with headgear wedges 75. Digital dental molds 75 are sent to machine 200. Material 201 is used with machine 200 in order to produce positive dental molds with headgear wedges 78.

Again referring to FIG. 2A, molds 78 are used with a pressure-forming machine 300. An appropriate pressure-forming machine is offered by Great Lakes Orthodontics, Ltd., Tonawanda, N.Y. 14150. A dental thermal forming sheet 301 is thermally pressure-formed over molds 78. Suitable dental thermal forming sheets are available from RainTree Essix, New Orleans, La. 70002. RainTree Essix, New Orleans, La. 70002 offers Essix A® in 0.020 inch, 0.030 inch, 0.040 inch, 0.060 inch, 0.080 inch, and, 0.120 inch thickness. Preferably, the 0.030 inch thick Essix A® thermal forming sheet is used. Alternatively, other thicknesses or materials may be used. Thicker sheets of dental thermal forming material are occasionally necessary when the practitioner desires additional appliance rigidity. Materials with a higher Shore Durometer hardness value than Essix A® may be used. A variety of polymer sheets of varying thickness are available from Catalina Plastics, Calabasas Hills, Calif. 91301. Alternative materials include acrylic, butyrate, polyethylene, styrene, acetate, vinyl, polyurethane rubber, high-temperature vulcanizing (HTV) silicone elastomer, LTV vinyl silicone rubber, thermoplastic vinyl, polyvinyl siloxane (silicone), copolyester, polycarbonate, and ethyl-vinyl-acetate. Alternatively, any other medical grade polymer may be used. The pressure-formed polymeric shell is then removed from the dental mold. The thickness of the pressure-formed polymeric material used in the construction process results in headgear attachment protrusions with a slightly higher width and length in relation to the wedges used to shape the headgear attachment protrusions. Preferably, step 80 involves pouring and curing acrylic in the protrusions created by the wedges on the positive tooth molds and drilling the appropriate dimension for channel 58. Alternatively, silicone is poured into the protrusions. Alternatively, light curable dental resin is used. Alternatively, TRlAD® TruTrayΦ available from Denstply International Inc., PA 17405, is filled in the protrusions. Alternatively, a larger hole is drilled through the protrusion to allow for adding a metal tube for reinforcement. Alternatively, channel 58 is drilled and acrylic is not poured into the protrusions. Alternatively, methyl methacrylate, available from Lang Dental Mfg., Co. Inc., Wheeling, I1 60090 under the brand name Jet® Liquid Acrylic, is thinly applied between the dental thermally formed sheet and the acrylic in order to improve adhesion of the acrylic to the polymeric material. The portions of the repositioner that will not influence treatment are then removed using a heated scalpel, scissors or rotary burr in order to create the polymeric appliance with headgear receiving protrusions. Alternatively, mold 78 is used to create more than one appliance with headgear receiving protrusions, which is occasionally desirable if the practitioner wishes to replace the appliance due to everyday wear or as a replacement in case the original appliance is lost or broken.

Referring to FIG. 3, a cutout as viewed from the patient's right side of an alternative embodiment of protrusion 56 is shown. The protrusion located on the patient's left side is a mirror image of the protrusion shown in FIG. 3. Channel 58 does not extend the length of protrusion 56. Material 57 forms a stop located at a distal portion of channel 58. Material 55 surrounds material 57 on the labial side.

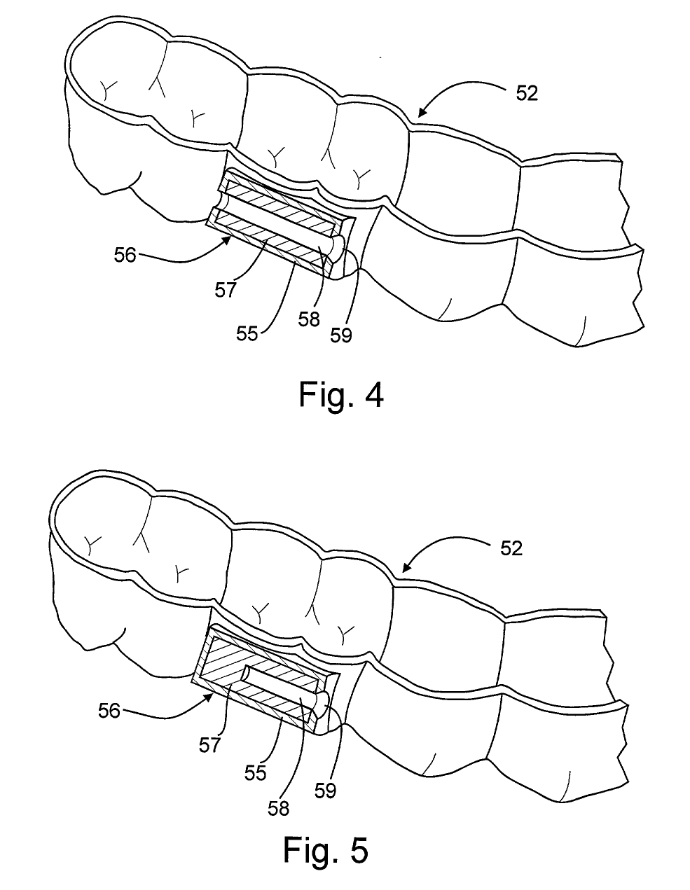

Alternatively, referring to FIG. 4, channel 58 has an oversized headgear-receiving hole 59. The diameter of hole 59 is larger than the diameter of channel 58. The surface between hole 59 and channel 58 forms a cone of decreasing diameter distally. Preferably, hole 59 is 50% larger in diameter than channel 58. Alternatively, hole 59 is at least 50% larger in diameter than channel 58. This is occasionally desirable in order to increase the ease of fitting the headgear receiving prongs into channel 58 for the patient. Channel 58 extends to the distal end of protrusion 56. Alternatively, referring to FIG. 5, channel 58 does not extend to the distal end of protrusion 56. Hole 59 and the cone shape entrance to channel 58 can be created using a larger drill bit than was used for creating channel 58.

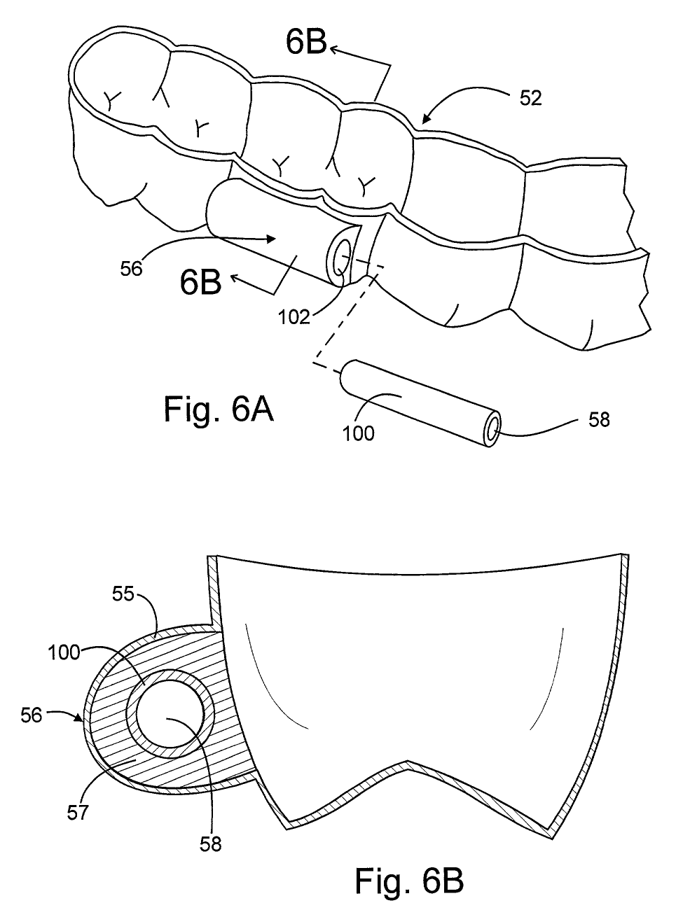

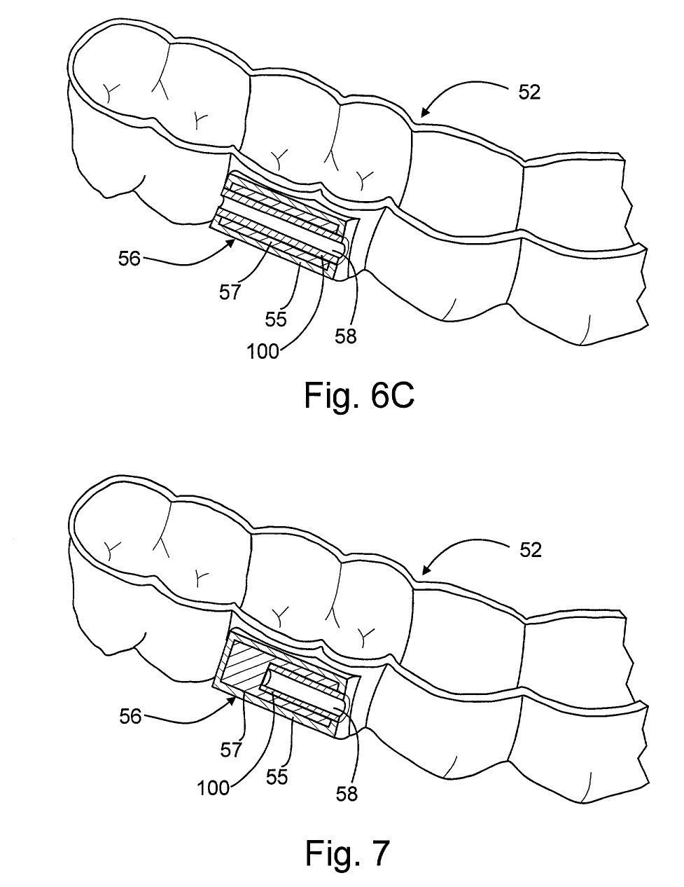

Alternatively, referring to FIG. 6A, protrusion 56 has a reinforcement tube 100 placed inside in order to provide structural stability. Tube 100 is placed through a hole 102. Tube 100 is constructed from stainless steel. Alternatively, tube 100 is constructed from plastic. Hole 102 is located at both the mesial and distal ends of protrusion 56. The diameter of hole 102 matches the outer diameter of tube 100. Tube 100 has an inner diameter of the previously described channel 58 and therefore defines channel 58. Tube 100 has a wall thickness of 0.01 inches. Alternatively, the wall thickness of tube 100 is at least 0.001 inches. Alternatively, tube 100 is a headgear tube commonly mounted to molar bands in the field of orthodontics. FIG. 6B shows a cross-section of FIG. 6A. Referring to 6B, protrusion 56 is filled with material 57. Material 57 is contained on the side of appliance 52 that faces the patient's cheek tissue by material 55. Material 57 surrounds tube 100. Tube 100 extends the length of protrusion 56. FIG. 6C shows a cross section as viewed from the patient's right side of tube 100 extending the length of protrusion 56. Tube 100 is surrounded by material 57. Material 57 is surrounded by material 55 in the direction of the patient's cheek tissue. Alternatively, referring to FIG. 7, tube 100 does not extend the length of protrusion 56. The distal end of channel 58 is formed by material 57. Tube 100 is surrounded by material 57.

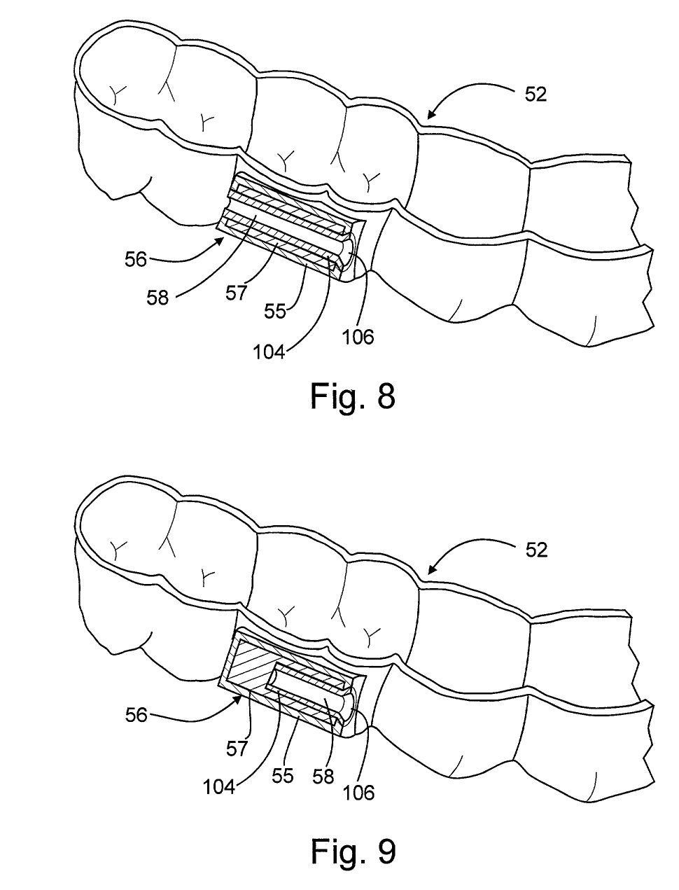

Alternatively, referring to FIG. 8, a tube 104 has channel 58 with a flared headgear receiving entrance 106. The diameter of entrance 106 is 50% larger than the inner diameter of tube 104. Alternatively, the diameter of entrance 106 is at least 5% larger than the inner diameter of tube 104. Tube 104 has an inner diameter dimension of the previously described dimensions of channel 58. Alternatively, referring to FIG. 9, tube 104 does not extend the length of protrusion 56. Tube 104 can be manufactured by molding, or by expanding the entrance of a standard tube using a punch.

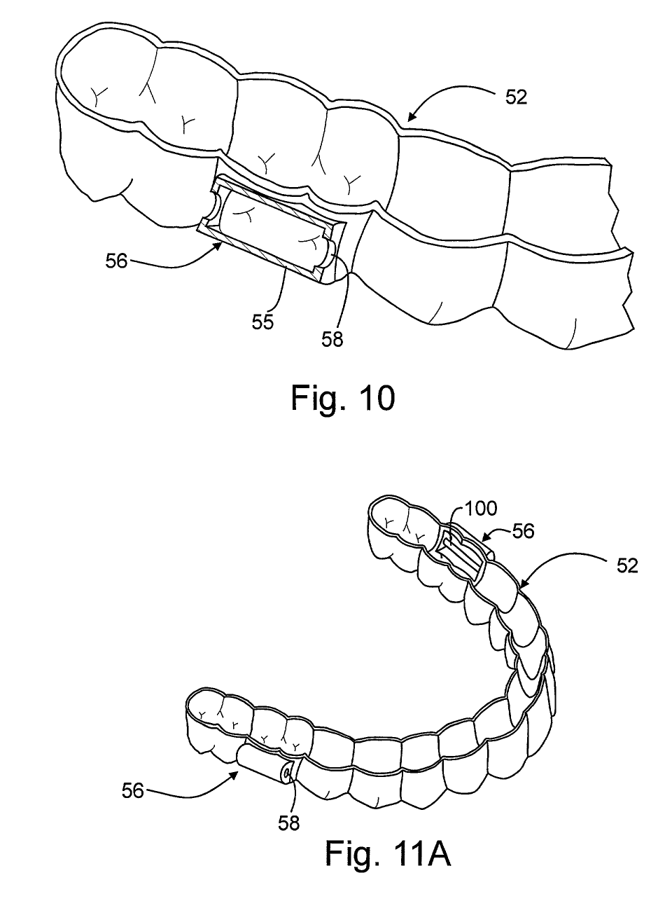

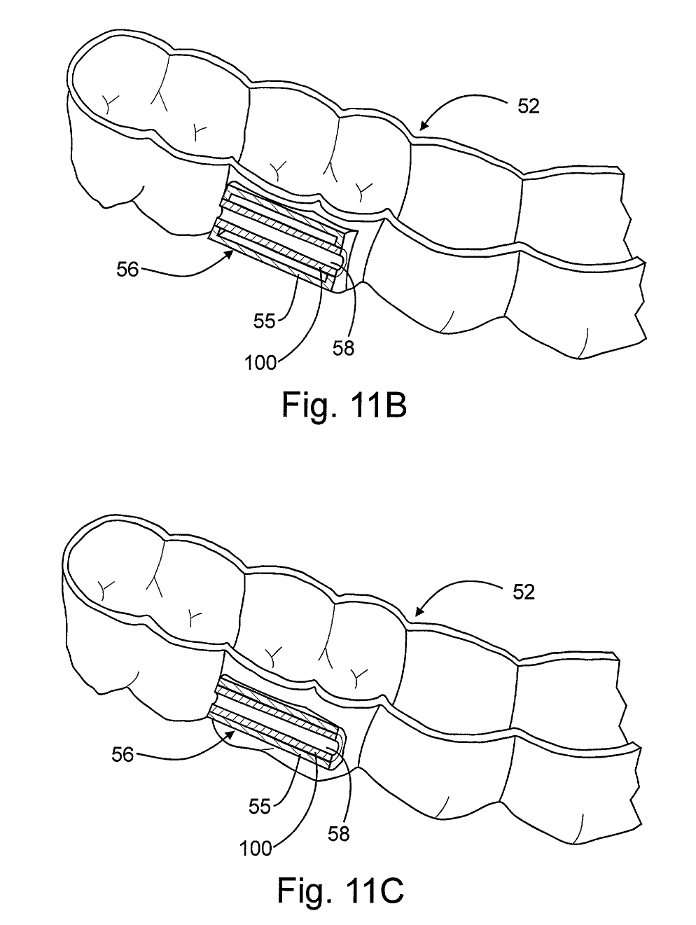

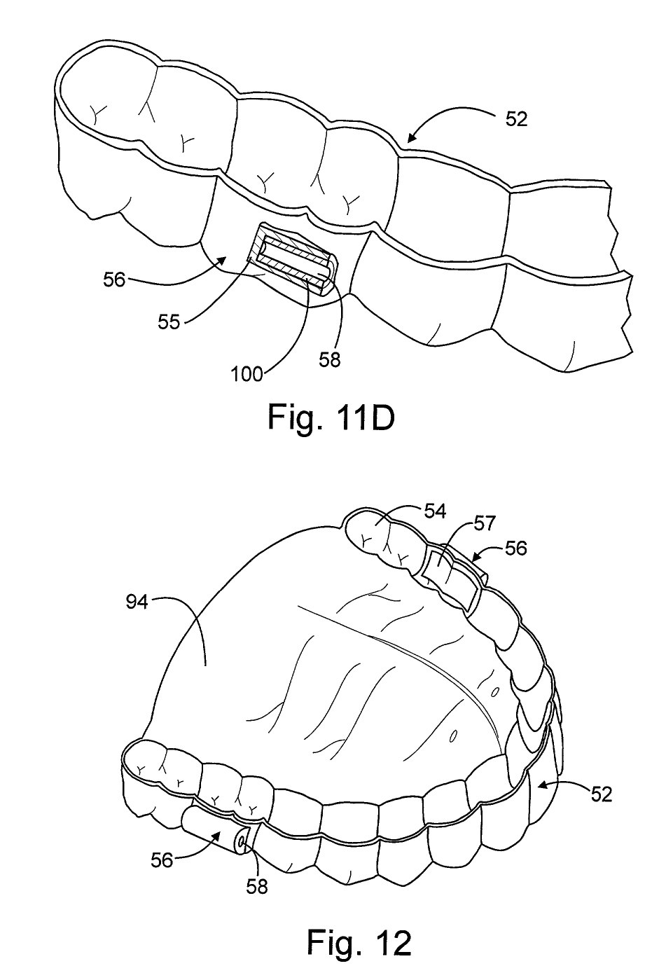

Alternatively, referring to FIG. 10, channel 58 is unsupported the length of protrusion 56. In these cases, protrusion 56 is not filled with material 57. Protrusion 56 contains a hole at the mesial end which forms channel 58. Alternatively, referring to FIG. 11 A, tube 100 is unsupported the length of protrusion 56. Tube 100 is inserted into holes at the mesial and distal protrusion 56. FIG. 11B shows a cross section as viewed from the patient's right side. Tube 100 is held in placed by holes at the mesial and distal end of protrusion 56. Alternatively, referring to FIG. 11C, material 55 surrounds and is in contact with tube 100 for the length of tube 100. Alternatively, referring to FIG. 11D, material 55 forms a distal stop of channel 58.

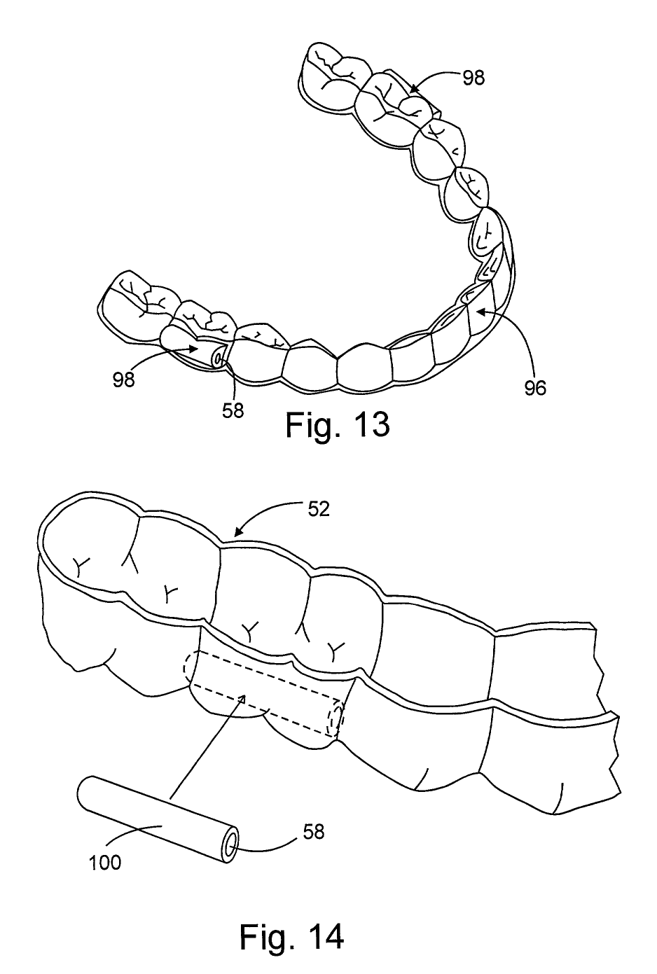

Alternatively, referring to FIG. 12, a palatte anchorage surface 94 is formed into appliance 52. This is occasionally desirable when the practitioner deems additional anchorage support necessary. Alternatively, referring to FIG. 13, a lower dental set appliance 96 is formed intended to receive a patient's lower dental set. Appliance 96 has protrusions 98 intended to receive the headgear prongs. Protrusions 98 can be constructed in any of the previously described embodiments of protrusion 56.

Alternatively, referring to FIG. 14, tube 100 is adhered to appliance 52 with acrylic and methyl methacrylate monomer. This embodiment generally requires the appliance to be constructed from an acetate sheet or some other material capable of bonding with acrylic and methyl methacrylate monomer, such as Essix A®. Alternatively, tube 100 is adhered with any biocompatible curable resin or composite. Alternatively, tube 100 is a headgear tube commonly mounted to molar bands in the field of orthodontics.

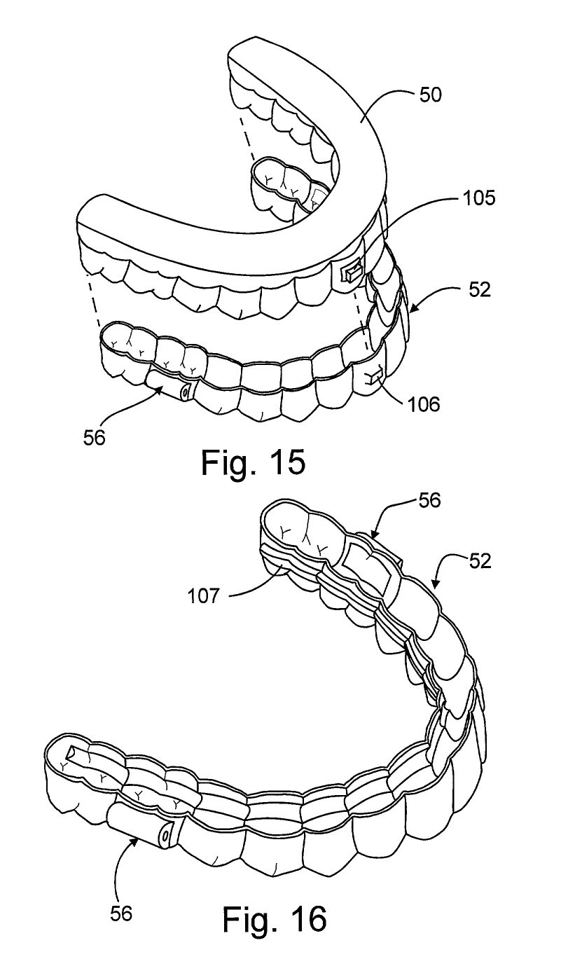

Alternatively, referring to FIG. 15, appliance 52 has an invagination 108 designed to receive an attachment appliance 105 mounted on the lingual surface of a tooth of dental set 50. Invagination 108 is meant to receive appliance 105 in order to provide additional anchorage for appliance 52. Appliance 105 can be an orthodontic bracket, button, cured composite material or any other appliance commonly attached to teeth in the field of orthodontics. Alternatively, invagination 106 is positioned so as to produce tooth correction forces through appliance 105 due to a difference in the position of appliance 105 on the tooth and the positioning or geometry of invagination 106. Alternatively, a plurality of invaginations is intended to receive a plurality of attachment appliances positioned on the teeth of the patient's dental set. Alternatively, invagination 106 is designed to receive appliance 105 attached to the lingual surface of the patient's dental set.

Alternatively, referring to FIG. 16, a groove 107 is formed on the lingual side of appliance 52. Groove 107 is designed to receive a plurality of attachment appliances mounted to the lingual side of the patient's dental set. Alternatively, groove 107 provides additional rigidity to appliance 52. Alternatively, groove 107 is filled with silicone, acrylic, plastic, a round metal wire, an orthodontic archwire, or cured composite material in order to provide structural support to appliance 52.

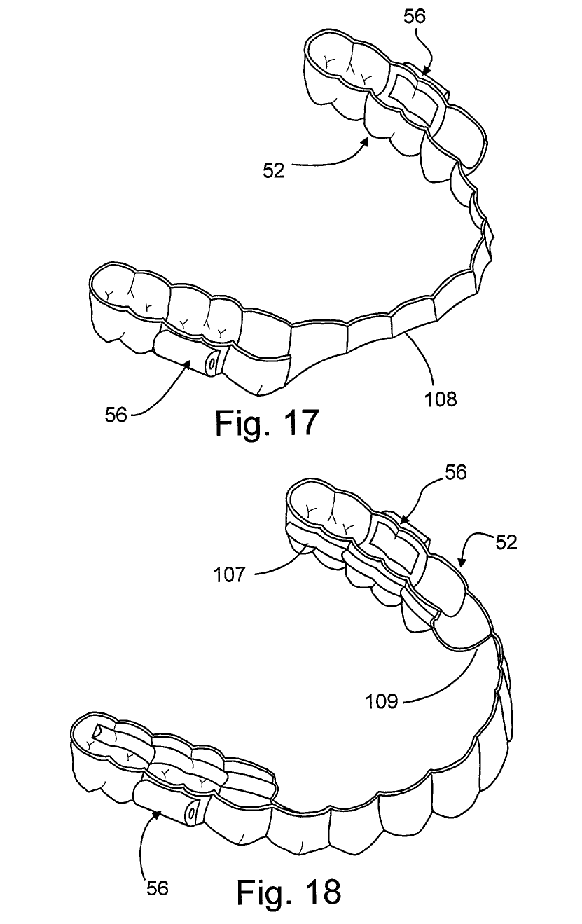

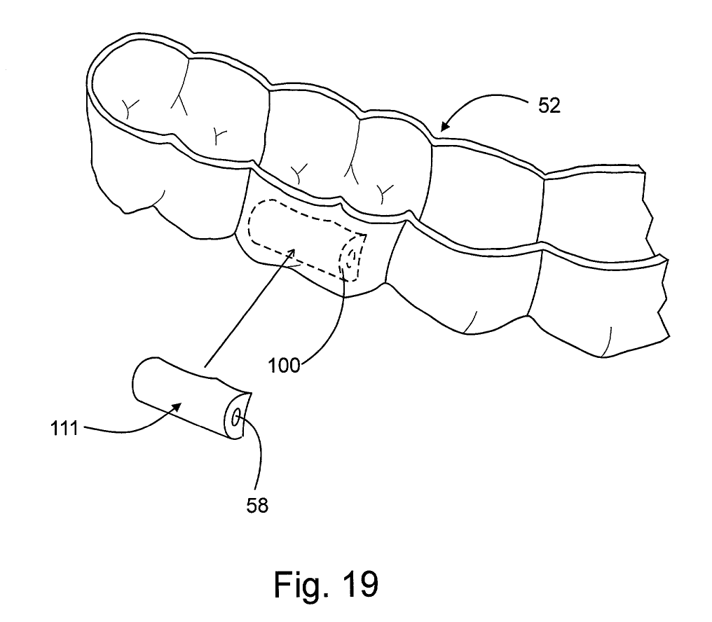

Alternatively, referring to FIG. 17, appliance 52 has a section 108 formed to only cover a portion of the teeth of a patient's dental set. Section 108 covers a portion of the lingual side of a patient's dental set. Appliance 52 illustrated in FIG. 18 is formed with a section 109 designed to only cover a portion of the labial surface of a patient's dental set. Additionally illustrated is groove 107, which does not span the entire length of the lingual surface of a patient's dental set. Alternatively, appliance 52 is formed with section 109 but without groove 107.

Alternatively, FIG. 19 illustrates a headgear receiving attachment appliance 111 adhered in the appropriate location to appliance 52 on the right side of the appliance 52. The other side is a mirror image. Alternatively, the other side is constructed utilizing one of the embodiments previously described. Alternatively, appliance 111 is secured to the left side of appliance 52. Appliance 111 has channel 58 as is formed from plastic, metal, acrylic, cured dental composite material or ceramic. Alternatively, appliance 111 is constructed from a plurality of materials. Appliance 111 is adhered with acrylic and methyl methacrylate monomer, custom impression tray light curable adhesive, or any other biocompatible adhesive. Alternatively, appliance 111 is rigidly fixed to appliance 52 using screws or rivets. Appliance 111 has the dimensions previously described for protrusion 56.

The portions of the appliance that do not influence treatment are removed with a rotary burr. Appliances that are constructed for incrementally moving teeth are generally only removed for maintaining oral hygiene. Appliances that are constructed with the tooth-receiving surface intended to receive the actual positions of the patient's dental arrangement are generally only worn with the headgear assembly inserted into the headgear receiving protrusions. This is generally only worn during the night, or as prescribed by the practitioner.

While the above description contains many specificities, these should not be construed as limitations on the scope of the invention, but rather as an exemplification of one preferred embodiment and various alternative embodiments. Many other variations are possible. Accordingly, the scope of the invention should be determined not by the embodiment(s) illustrated, but by the appended claims and their legal equivalents.

What is claimed is:

1. An improved, substantially thin, removable polymeric orthodontic appliance capable of receiving a headgear comprising:
a) A substantially thin polymeric shell with tooth receiving cavities meant to receive a patient's dentition and;
b) Said substantially thin polymeric shell having two labially positioned protrusions located on substantially opposite sides of said substantially thin polymeric shell and;
c) Said labially positioned protrusions each having a channel meant to receive an end of said headgear;
Whereby the end of said headgear can be placed and removed by the patient into said channels and;
Whereby said removable polymeric orthodontic appliance does not require the use of a molar band having a welded headgear tube for receiving said headgear.

2. The removable polymeric orthodontic appliance of claim 1 wherein said labially positioned protrusions are integrally formed with said substantially thin polymeric shell and said protrusions are substantially hollow.

3. The removable polymeric orthodontic appliance of claim 1 wherein at least one of said protrusions is filled with acrylic and said channel extends through said acrylic.

4. The removable polymeric orthodontic appliance of claim 3 wherein said substantially thin polymeric shell is designed to receive a patient's maxillary dentition.

5. The removable polymeric orthodontic appliance of claim 1 wherein said substantially thin polymeric shell is designed to receive a patient's mandibular dentition.

6. The removable polymeric orthodontic appliance of claim 1 wherein said channel is contained within a hollow, cylindrical tube.

7. The removable polymeric orthodontic appliance of claim 6 wherein said hollow, cylindrical tube is stainless steel.

8. The removable polymeric orthodontic appliance of claim 7 wherein said protrusion is filled with acrylic and said acrylic surrounds said tube.

9. The removable polymeric orthodontic appliance of claim 1 wherein said substantially thin polymeric shell comprises at least one tooth receiving cavity different than the actual position of a tooth of said patient's dentition said tooth receiving cavity is intended to receive.

10. The removable polymeric orthodontic appliance of claim 1 wherein at least one of said protrusions is adhered to said substantially thin polymeric shell.

11. The removable polymeric orthodontic appliance of claim 1 wherein at least one of said protrusions is rigidly fixed to said polymeric shell.

12. The removable orthodontic appliance of claim 1 wherein said substantially thin polymeric shell is substantially clear.

13. A method of repositioning teeth of a patient's dental set, comprising the steps of:
a) Providing a substantially thin, removable polymeric shell with tooth receiving cavities meant to receive a patient's dentition and;
b) Providing said substantially thin polymeric shell with two labially positioned protrusions located on substantially opposite sides of said substantially thin polymeric shell and;
c) Providing said labially positioned protrusions having a channel meant to receive an end of said headgear;
Whereby the end of said headgear can be placed and removed by the patient into said channels and produces tooth repositioning forces and;
Whereby said removable polymeric shell with said labially positioned protrusions does not require the use of a molar band having a welded headgear tube for receiving said headgear.

14. The method of claim 13 wherein said labially positioned protrusions are integrally formed with said removable polymeric shell and said protrusions are substantially hollow

15. The method of claim 13 wherein at least one of said protrusions is filled with acrylic and said channel extends through said acrylic.

16. The method of claim 15 wherein said substantially thin polymeric shell is designed to receive a patient's maxillary dentition.

17. The method of claim 13 wherein said substantially thin polymeric shell is designed to receive a patient's mandibular dentition.

18. The method of claim 13 wherein at least one of said channels is contained within a hollow, cylindrical tube.

19. The method of claim 18 wherein said hollow, cylindrical tube is stainless steel.

20. The method of claim 19 wherein said hollow, cylindrical tube is substantially surrounded by acrylic.

21. The method of claim 13 wherein said substantially thin polymeric shell comprises at least one tooth receiving cavity different than the actual position of a tooth of said patient's dentition said tooth receiving cavity is intended to receive.

22. The method of claim 13 wherein at least one of said protrusions is adhered to said substantially thin polymeric shell.

23. The method of claim 13 wherein at least one of said protrusions is rigidly fixed to said polymeric shell.

24. The method of claim 13 wherein said substantially thin polymeric shell is substantially clear.

25. An improved, substantially thin, removable polymeric orthodontic appliance capable of receiving a headgear comprising:
a) A substantially thin polymeric shell with tooth receiving cavities meant to receive a patient's dentition and;
b) Headgear receiving means for receiving ends of said headgear positioned on said substantially thin polymeric shell;
Whereby the end of said headgear can be placed and removed by the patient into said channels and;
Whereby said removable polymeric orthodontic appliance does not require the use of a molar band having a welded headgear tube for receiving said headgear.
